(19) United States
(12) Patent Application Publication
(10) Pub. No.: US 2026/0329122 A1
(43) Pub. Date: Oct. 22, 2026

(54) SWITCHABLE LIGHT MODULATOR DISPLAYING DIFFERENT COLORS ON OPPOSITE VIEWING SIDES

(71) Applicant: E INK CORPORATION, Billerica, MA (US)

(72) Inventors: Hjalmar Edzer Ayco HUITEMA, Lexington, MA (US); Stephen J. TELFER, Arlington, MA (US); Hui DU, Lexington, MA (US); Dan LUO, Lexington, MA (US); Karl Raymond AMUNDSON, Cambridge, MA (US); Yu XIA, Acton, MA (US)

(21) Appl. No.: 19/534,195

(22) Filed: Feb. 9, 2026

Related U.S. Application Data
(60) Provisional application No. 63/758,837, filed on Feb. 14, 2025.

(51) Int. Cl. G02F 1/1333; G02F 1/167; G02F 1/1685; B60J 3/04; E06B 9/24

(52) U.S. Cl. CPC G02F 1/133342; G02F 1/167; G02F 1/1685; B60J 3/04; E06B 9/24; E06B 2009/2464

(57) ABSTRACT

A switchable light modulator and method utilize an electrophoretic medium for attenuating light transmission as well as displaying different colors on opposite viewing sides. Such a light modulator may be used, e.g., in windows of buildings or vehicles for displaying different colors or images as well as modulating light transmission.

### CROSS REFERENCE TO RELATED APPLICATION(S)

This application claims priority from U.S. Provisional Patent Application No. 63/758,837 filed on Feb. 14, 2025, entitled SWITCHABLE LIGHT MODULATOR DISPLAYING DIFFERENT COLORS ON OPPOSITE VIEWING SIDES, which is hereby incorporated by reference in its entirety.

### BACKGROUND

The present invention generally relates to electrophoretic and other electro-optic light modulating films. Light modulating films modulate the amount of light or other electro-magnetic radiation passing through an electrophoretic medium. In some instances, the light will pass completely through the film (i.e., from top to bottom). In other instances, the light may pass through the electrophoretic medium, reflect/scatter off a surface, and return through the medium a second time (i.e., from top to bottom surfaces and back to top.) In other instances, the light will be absorbed by pigment particles present at the viewing surface. In other instances, selective absorption of the light by pigment particles will result in a rendered image, e.g., text or a picture. Such films can be incorporated into displays, signs, variable transmission windows, mirrors, displays, and similar devices. Typically the films have an “open” state, in which one or more sets of pigment particles are isolated to the side or in wells, etc., so that most of the incident light can pass through the medium, and a “closed” state, in which one or more sets of pigment particles are distributed across the medium to absorb some or all of the incident light.

For example, U.S. Patent No. 10,067,398 discloses an electrophoretic light attenuator comprising a cell including a first substrate, a second substrate spaced apart from the first substrate, a layer disposed between the substrates containing an electrophoretic ink, and a monolayer of closely packed protrusions projecting into the electrophoretic ink and arranged adjacent a surface of the second substrate. The protrusions have surfaces defining a plurality of depressions between adjacent protrusions. The electrophoretic medium layer (ink layer) includes charged particles of at least one type. The particles are responsive to an electric field applied to the cell to move between a first extreme light state, in which the particles are generally maximally spread within the cell so as to lie in the path of light through the cell and thus strongly attenuate light transmitted from one substrate to the opposite substrate, and a second extreme light state, in which the particles are generally maximally concentrated within the depressions so as to let light be transmitted. The total area corresponding to the concentrated particles in the depressions is a fraction of the total face area.

Devices of this type rely at least in part on the shape of their non-planar, polymer structure to concentrate absorbing charged particles (e.g., black particles) in an electrophoretic ink in a transparent light state thereby forming (or exposing) light apertures (i.e., transmitting areas) and light obstructions (i.e., strongly absorbing areas). The present application additionally relates to more traditional electrophoretic displays, such as described in U.S. Patent Nos. 9,921,451 and 9,812,073, which modulate the light reflected at the viewing surface with the presence of charged pigment particles.

For convenience, the term "light" will normally be used herein, but this term should be understood in a broad sense to include electro-magnetic radiation at non-visible wavelengths. For example, the present invention may be applied to provide windows that can modulate infra-red radiation for controlling temperatures within buildings or vehicles. More specifically, this invention relates to light modulators that use particle-based electrophoretic media to control light modulation. Examples of electrophoretic media that may be incorporated into various embodiments of the present invention include, e.g., the electrophoretic media described in U.S. Patent Nos. 10,809,590 and 10,983,410, the contents of both of which are incorporated by reference herein in their entireties.

Prior art solutions that have a polymer structure in the fluid or gel layer suitable for use with the invention include U.S. Patent No. 8,508,695 to Vlyte Innovations Ltd., which discloses dispersing fluid droplets (1 to 5 microns in diameter) in a continuous polymer matrix that is cured in place to both substrates, to contain liquid crystals. Additionally, U.S. Patent No. 10,809,590 to E Ink Corporation discloses microencapsulating fluid droplets and deforming them to form a monolayer of close packed polymer shells in a polymer matrix on one substrate and subsequently applying an adhesive layer to bond the capsule layer to a substrate. Also, European Patent Application Publication EP1264210 to E Ink California discloses embossing a micro-cup structure on one substrate, filling the cups with fluid having polymerizable components and polymerizing the components to form a sealing layer on the fluid/cup surface, then applying an adhesive layer to bond to the second substrate. Additionally, EP2976676 to Vlyte Innovations Ltd. discloses forming a wall structure on one substrate, coating the tops of walls with adhesive, filling the cavities defined by the walls with fluid, and polymerizing the adhesive to bond the tops of walls to the opposing substrate. EP3281055 describes a flexible device including solid polymer microstructures embedded in its viewing area and the microstructures are on both substrates. The microstructures join (i.e., fasten) the substrates of the device to each other by engaging with each other over a length orthogonal to the substrates. The joined microstructures incorporate a wall structure that divides a device’s fluid layer into a monolayer of discrete volumes contained within corresponding cavities. This provides the device with significant structural strength. In the method described, mating microstructures (i.e., male and female parts) are formed on each substrate, then precisely aligned with each other and joined in a press fit that also seals the fluid layer in the cavities.

Particle-based electrophoretic displays, in which a plurality of charged particles move through a suspending fluid under the influence of an electric field, have been the subject of intense research and development for a number of years. Such displays can have attributes of good brightness and contrast, wide viewing angles, state bistability, and low power consumption when compared with liquid crystal displays. The terms "bistable" and "bistability" are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, e.g., at least four times, the minimum duration of the addressing pulse required to change the state of the display element. It is shown in U.S. Patent No. 7,170,670 that some particle-based electrophoretic displays capable of gray scale are stable not only in their extreme black and white states but also in their intermediate gray states, and the same is true of some other types of electro-optic displays. This type of display is properly called "multi-stable" rather than bistable, although for convenience the term "bistable" may be used herein to cover both bistable and multi-stable displays.

As noted above, electrophoretic media require the presence of a suspending fluid. In most prior art electrophoretic media, this suspending fluid is a liquid, but electrophoretic media can be produced using gaseous suspending fluids; see, e.g., Kitamura, T., et al., "Electrical toner movement for electronic paper-like display", IDW Japan, 2001, Paper HCS1-1, and Yamaguchi, Y, et al., "Toner display using insulative particles charged triboelectrically", IDW Japan, 2001, Paper AMD4-4). See also European Patent Applications 1,429,178; 1,462,847; and 1,482,354; and International Applications WO 2004/090626; WO 2004/079442; WO 2004/077140; WO 2004/059379; WO 2004/055586; WO 2004/008239; WO 2004/006006; WO 2004/001498; WO 03/091799; and WO 03/088495. Such gas-based electrophoretic media appear to be susceptible to the same types of problems due to particle settling as liquid-based electrophoretic media, when the media are used in an orientation that permits such settling, e.g., in a sign where the medium is disposed in a vertical plane. Indeed, particle settling appears to be a more serious problem in gas-based electrophoretic media than in liquid-based ones since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation, E Ink California, LLC, and related companies describe various technologies used in encapsulated and microcell electrophoretic and other electro-optic media. Encapsulated electrophoretic media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. In a microcell electrophoretic display, the charged particles and the fluid are not encapsulated within microcapsules but instead are retained within a plurality of cavities formed within a carrier medium, typically a polymeric film. The technologies described in these patents and applications include:
(a) Electrophoretic particles, fluids and fluid additives; see, e.g., U.S. Patent No. 7,002,728;
(b) Capsules, binders and encapsulation processes; see, e.g., U.S. Patent Nos. 6,922,276 and 7,411,719;
(c) Microcell structures, wall materials, and methods of forming microcells; see, e.g., U.S. Patent Nos. 7,072,095 and 9,279,906;
(d) Methods for filling and sealing microcells; see, e.g., U.S. Patents No. 7,715,088 and U.S. Patent Application Publication No. 2002/0188053;
(e) Films and sub-assemblies containing electro-optic materials; see, e.g., U.S. Patent Nos. 6,982,178 and 7,839,564;
(f) Backplanes, adhesive layers and other auxiliary layers and methods used in displays; see, e.g., U.S. Patent Nos. 7,116,318 and 7,535,624;
(g) Color formation and color adjustment; see, e.g., U.S. Patent Nos. 7,075,502 and 7,839,564;
(h) Methods for driving displays; see, e.g., U.S. Patent Nos. 7,012,600 and 7,453,445;
(i) Applications of displays; see, e.g., U.S. Patent Nos. 7,312,784 and 8,009,348; and
(j) Non-electrophoretic displays, as described in U.S. Patent No. 6,241,921 and U.S. Patent Applications Publication No. 2015/0277160; and applications of encapsulation and microcell technology other than displays; see, e.g., U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see, e.g., the aforementioned U.S. Patent Application Publication No. 2002/0131147. Accordingly, for purposes of the present application, such polymer-dispersed electrophoretic media are regarded as sub-species of encapsulated electrophoretic media.

A related type of electrophoretic display is a so-called "microcell electrophoretic display". In a microcell electrophoretic display, the charged particles and the suspending fluid are not encapsulated within microcapsules but instead are retained within a plurality of cavities formed within a carrier medium, typically a polymeric film. See, e.g., International Application Publication No. WO 02/01281, and published U.S. Application Publication No. 2002/0075556, both assigned to SiPix Imaging, Inc.

Electrophoretic media are often opaque (since, e.g., in many electrophoretic media, the particles substantially block transmission of visible light through the display) and operate in either a light-absorptive or a light-reflective mode. However, electrophoretic devices can also be made to operate in a so-called “shutter mode,” in which one display state is substantially opaque, and one is substantially light-transmissive. See, e.g., the aforementioned U.S. Patent Nos. 6,130,774 and 6,172,798, and U.S. Patent Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Patent No. 4,418,346. Other types of electro-optic displays may also be capable of operating in shutter mode. In particular, when this “shutter mode” electrophoretic device is constructed on a transparent substrate, it is possible to regulate transmission of light through the device.

An encapsulated or microcell electrophoretic display typically does not suffer from the clustering and settling failure mode of traditional electrophoretic devices and provides further advantages, such as the ability to print or coat the display on a wide variety of flexible and rigid substrates. (Use of the word "printing" is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition; and other similar techniques.) Thus, the resulting display can be flexible. Further, because the display medium can be printed (using a variety of methods), the display itself can be made inexpensively.

One potentially important market for electrophoretic media is windows with variable light transmission. As the energy performance of buildings becomes increasingly important, electrophoretic media can be used as coatings on windows to enable the proportion of incident radiation transmitted through the windows to be electronically controlled by varying the optical state of the electrophoretic media. Effective implementation of such "variable-transmissivity" ("VT") technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile or other vehicle, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

### SUMMARY

A switchable light modulator according to a first aspect of the invention has a first viewing side and an opposite second viewing side. The light modulator includes a first light-transmissive substrate at the first viewing side; a first electrode layer superposed on one side of the first light-transmissive substrate; a second light-transmissive substrate at the second viewing side; a second electrode layer superposed on one side of the second light-transmissive substrate; and a light-transmissive polymer structure between the first electrode layer and the second electrode layer. The light-transmissive polymer structure includes a base superposed on the first electrode layer or on the second electrode layer. A wall structure extends orthogonally from the base defining a plurality of cells, each of which includes a plurality of wells in the base. An electrophoretic medium is contained in each of the cells. The electrophoretic medium comprises a non-polar fluid and a first set of charged pigment particles and a second set of charged pigment particles dispersed in the non-polar fluid. The first and second sets of charged pigment particles have different colors and are selectively movable through the non-polar fluid under influence of an electric field. A controller is configured to apply a set of driving voltages between the first and second electrode layers to selectively drive the electrophoretic medium among a plurality of optical states including at least the following: (a) an open state (depicted, e.g., in FIG. 5A), in which the first and second sets of charged pigment particles are concentrated in the wells in the polymer structure to promote transmittance of incident light through the switchable light modulator; (b) a first closed state (depicted, e.g., in FIG. 5B) in which the second set of charged pigment particles is spread across each cell and the first set of charged pigment particles is spread across each cell between the second set of charged pigment particles and the first electrode layer such that the color of the first set of charged pigment particles is displayed across the first viewing side, and the color of the second set of charged pigment particles is displayed across the second viewing side; and (c) a second closed state (depicted, e.g., in FIG. 5C) in which the first set of charged pigment particles is spread across each cell and the second set of charged pigment particles is spread across each cell between the first set of charged pigment particles and the first electrode layer such that the color of the second set of charged pigment particles is displayed across the first viewing side, and the color of the first set of charged pigment particles is displayed across the second viewing side.

In one or more embodiments, the controller is configured to apply an additional set of driving voltages between the first and second electrode layers to selectively drive the electrophoretic medium among a plurality of additional optical states including at least the following: (d) a third closed state (depicted, e.g., in FIG. 5D) in which the first set of charged pigment particles is spread across each cell at the first electrode layer, and the second set of charged pigment particles is concentrated in the wells in the polymer structure such that the first viewing side displays the color of the first set of charged pigment particles, and the second viewing side displays the color of the first set of charged pigment particles marked with the color of the second set of charged pigment particles at the wells; and (e) a fourth closed state (depicted, e.g., in FIG. 5E) in which the second set of charged pigment particles is spread across each cell at the first electrode layer, and the first set of charged pigment particles is concentrated in the wells in the polymer structure such that the first viewing side displays the color of the second set of charged pigment particles, and the second viewing side displays the color of the second set of charged pigment particles marked with the color of the first set of charged pigment particles at the wells.

In one or more embodiments, the electrophoretic medium further comprises a third set of charged pigment particles dispersed in the non-polar fluid. The third set of charged pigment particles have a different color than the first and second sets of charged pigment particles. The controller is configured to apply driving voltages between the first and second electrode layers to selectively drive the electrophoretic medium among a plurality of additional optical states including at least the following: (f) a fifth closed state (depicted, e.g., in FIG. 6A) in which the first set of charged pigment particles is spread across each cell at the first electrode layer, the second set of charged pigment particles is spread across each cell, and the third set of charged pigment particles is spread across each cell between the first and second sets of charged pigment particles such that the first viewing side displays the color of the first set of charged pigment particles influenced by the third set of charged pigment particles, and the second viewing side displays the color of the second set of charged pigment particles influenced by the third set of charged pigment particles; and (g) a sixth closed state (depicted, e.g., in FIG. 6B) in which the second set of charged pigment particles is spread across each cell at the first electrode layer, the first set of charged pigment particles is spread across each cell, and the third set of charged pigment particles is spread across each cell between the first and second sets of charged pigment particles such that the first viewing side displays the color of the second set of charged pigment particles influenced by the third set of charged pigment particles, and the second viewing side displays the color of the first set of charged pigment particles influenced by the third set of charged pigment particles.

In one or more embodiments, the controller is configured to apply driving voltages between the first and second electrode layers to selectively drive the electrophoretic medium among a plurality of additional optical states including at least the following: (h) a seventh closed state (depicted, e.g., in FIG. 6C) in which a mixture of the first and second sets of charged pigment particles is spread in a layer across each cell at the first electrode layer, and the third set of charged pigment particles is spread in a layer across each cell between the mixture of the first and second sets of charged pigment particles and the second electrode layer such that the first viewing side displays the color produced by the mixture of the first and second sets of charged pigment particles, and the second viewing side displays the color of the third set of charged pigment particles; and (i) an eighth closed state (depicted, e.g., in FIG. 6D) in which the third set of charged pigment particles is spread across each cell at the first electrode layer, the mixture of the first and second sets of charged pigment particles is spread across each cell between the third set of charged pigment particles and the second electrode layer such that the first viewing side displays the color of the third set of charged pigment particles and the second viewing side displays the color produced by the mixture of the first and second sets of charged pigment particles.

In one or more embodiments, the first and second sets of charged pigment particles comprise light-scattering charged pigment particles or light-absorbing charged pigment particles. In one or more embodiments, the third set of charged pigment particles comprises light-absorbing black pigment particles or light-scattering white pigment particles.

In one or more embodiments, (i) the first set of charged pigment particles comprises light-scattering charged pigment particles and the second set of charged pigment particles comprises light-absorbing charged pigment particles, (ii) the first set of charged pigment particles comprises light-absorbing charged pigment particles and the second set of charged pigment particles comprises light-scattering charged pigment particles, (iii) the first set of charged pigment particles and the second set of charged pigment particles comprise light-absorbing charged pigment particles, or (iv) the first set of charged pigment particles and the second set of charged pigment particles comprise light-scattering charged pigment particles.

In one or more embodiments, the light-absorbing charged pigment particles are black particles (or a combination of different particles producing a black color), and the light-scattering charged pigment particles are white, brown, red, blue, cyan, green, orange, yellow, violet, or purple particles.

In one or more embodiments, in the open state, the switchable light modulator has light transmittance therethrough of at least 50%.

In one or more embodiments, the set of driving voltages for driving the electrophoretic medium to one of the optical states includes a series of alternating positive and negative voltage pulses repeated a plurality of times to induce macroscopic fluid flow in the electrophoretic medium to spread one or more of the sets of charged pigment particles out across each of the plurality of cells.

In one or more embodiments, the set of driving voltages for driving the electrophoretic medium to one of the optical states includes a direct current bias or a push-pull waveform to promote ordering of the sets of charged pigment particles.

In one or more embodiments, the base of the light-transmissive polymer structure includes (i) a plurality of pyramidal or conical-shaped features, each surrounded by an annular well or (ii) a plurality of toroidal shaped features, each having a center well and surrounded by an annular well.

In one or more embodiments, a window of a building or a vehicle includes the switchable light modulator.

In one or more embodiments, a sunroof of a vehicle includes the switchable light modulator, wherein the first viewing side faces outside the vehicle and the second viewing side faces inside the vehicle, wherein in the first closed state the first viewing side displays the color of the first set of charged pigment particles, which color is associated with an exterior body color of the vehicle, and the second viewing side displays the color of the second set of charged pigment particles, which color is associated with an interior color of the vehicle.

According to another aspect of the invention, a method is disclosed for operating a switchable light modulator. The method includes applying a set of driving voltages between the first and second electrode layers to selectively drive the electrophoretic medium among a plurality of optical states including at least the following: (a) an open state, in which the first and second sets of charged pigment particles are concentrated in the wells in the polymer structure to promote transmittance of incident light through the switchable light modulator; (b) a first closed state in which the second set of charged pigment particles is spread across each cell and the first set of charged pigment particles is spread across each cell between the second set of charged pigment particles and the first electrode layer such that the color of the first set of charged pigment particles is displayed across the first viewing side, and the color of the second set of charged pigment particles is displayed across the second viewing side; and (c) a second closed state in which the first set of charged pigment particles is spread across each cell and the second set of charged pigment particles is spread across each cell between the first set of charged pigment particles and the first electrode layer such that the color of the second set of charged pigment particles is displayed across the first viewing side, and the color of the first set of charged pigment particles is displayed across the second viewing side.

In one or more embodiments, the method further comprises applying an additional set of driving voltages between the first and second electrode layers to selectively drive the electrophoretic medium among a plurality of additional optical states including at least the following: (d) a third closed state in which the first set of charged pigment particles is spread across each cell at the first electrode layer, and the second set of charged pigment particles is concentrated in the wells in the polymer structure such that the first viewing side displays the color of the first set of charged pigment particles, and the second viewing side displays the color of the first set of charged pigment particles marked with the color of the second set of charged pigment particles at the wells; and (e) a fourth closed state in which the second set of charged pigment particles is spread across each cell at the first electrode layer, and the first set of charged pigment particles is concentrated in the wells in the polymer structure such that the first viewing side displays the color of the second set of charged pigment particles, and the second viewing side displays the color of the second set of charged pigment particles marked with the color of the first set of charged pigment particles at the wells.

In one or more embodiments, the electrophoretic medium further comprises a third set of charged pigment particles dispersed in the non-polar fluid. The third set of charged pigment particles has a different color than the first and second sets of charged pigment particles. The method further comprises applying driving voltages between the first and second electrode layers to selectively drive the electrophoretic medium among a plurality of additional optical states including at least the following: (f) a fifth closed state in which the first set of charged pigment particles is spread across each cell at the first electrode layer, the second set of charged pigment particles is spread across each cell, and the third set of charged pigment particles is spread across each cell between the first and second sets of charged pigment particles such that the first viewing side displays the color of the first set of charged pigment particles influenced by the third set of charged pigment particles, and the second viewing side displays the color of the second set of charged pigment particles influenced by the third set of charged pigment particles; and (g) a sixth closed state in which the second set of charged pigment particles is spread across each cell at the first electrode layer, the first set of charged pigment particles is spread across each cell, and the third set of charged pigment particles is spread across each cell between the first and second sets of charged pigment particles such that the first viewing side displays the color of the second set of charged pigment particles influenced by the third set of charged pigment particles, and the second viewing side displays the color of the first set of charged pigment particles influenced by the third set of charged pigment particles.

These and other aspects of the present invention will be apparent in view of the following description.

### BRIEF DESCRIPTION OF THE DRAWINGS

Embodiments of the invention will now be described, by way of example, with reference to the accompanying drawings, in which:

FIG. 1 is a simplified diagram illustrating an exemplary switchable electrophoretic light modulator.

FIG. 2A is a perspective view of a portion of one example of a prior art polymer structure forming part of an electrophoretic ink layer of the switchable light modulator.

FIG. 2B is a simplified cross-sectional view of a portion of the light modulator with the polymer structure of FIG. 2A showing the device in a closed state in which the charged pigment particles are distributed across the cells of the device and absorb incident light.

FIGS. 3A and 3B are cross-sectional and top plan views, respectively, of another prior art light modulator unit in an open state.

FIGS. 4A and 4B are perspective views of a portion of another example of a prior art polymer structure forming part of an electrophoretic ink layer of the switchable light modulator.

FIG. 5A is a simplified cross-sectional view of a portion of a switchable light modulator in accordance with one or more embodiments in an open state.

FIGS. 5B-5E are simplified cross-sectional views of the switchable light modulator of FIG. 5A in various closed states in accordance with one or more embodiments.

FIGS. 6A-6D are simplified cross-sectional views of a portion of a switchable light modulator having three sets of pigments in closed states in accordance with one or more further embodiments.

The drawings depict one or more implementations in accord with the present concepts, by way of example only, not by way of limitations.

### DETAILED DESCRIPTION

Various embodiments disclosed herein relate to a switchable light modulator utilizing an electrophoretic medium for attenuating light transmission and for displaying different colors on opposite viewing sides. Such a light modulator may be used, e.g., in windows of buildings or vehicles for displaying different colors or images as well as modulating light.

The switchable light modulator utilizes an electro-optic medium such as an electrophoretic ink. The electrophoretic ink comprises colored, charged particles in a suspending fluid and is in contact with the surface of a non-planar, polymer structure. The colored, charged particles can be any color, including black or white. Preferably, the suspending fluid is transparent, and refractive index matches the transparent, non-planar, polymer structure for at least one wavelength in the visible spectrum (typically 550 nm), and is a match or near match (i.e., within 0.01) for other visible light wavelengths. Consequently, in the absence of the colored charged particles, visible light rays (for the matched wavelength) experience negligible refraction at the interface between the suspending fluid and the non-planar, polymer structure.

Additionally, the charged pigment particles may be functionalized with surface polymers to improve state stability. Such pigments are described, e.g., in U.S. Patent No. 9,921,451, which is incorporated by reference in its entirety. For example, if the charged particles are of a white color, they may be formed from an inorganic pigment such as TiO₂, ZrO₂, ZnO, Al₂O₃, Sb₂O₃, BaSO₄, PbSO₄ or the like. They may also be polymer particles with a high refractive index (>1.5) and of a certain size (>100 nm) to exhibit a white color, to be substantially light-transmissive, or composite particles engineered to have a desired index of refraction. Such particles may include, e.g., poly(pentabromophenyl methacrylate), poly(2-vinylnapthalene), poly(naphthyl methacrylate), poly(alphamethylstyrene), poly(N-benzyl methacrylamide) or poly(benzyl methacrylate). Black charged particles may be formed from CI pigment black 26 or 28 or the like (e.g., manganese ferrite black spinel or copper chromite black spinel) or carbon black. Other colors (non-white and non-black) may be formed from organic pigments such as CI pigment PR 254, PR122, PR149, PG36, PG58, PG7, PB28, PB15:3, PY83, PY138, PY150, PY155 or PY20. Other examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Novoperm Yellow HR-70-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow. Color particles can also be formed from inorganic pigments, such as CI pigment blue 28, CI pigment green 50, CI pigment yellow 227, and the like. The surface of the charged particles may be modified by known techniques based on the charge polarity and charge level of the particles required, as described in U.S. Patent Nos. 6,822,782, 7,002,728, 9,366,935, and 9,372,380 as well as U.S. Patent Application Publication No. 2014-0011913, the contents of all of which are incorporated herein by reference in their entireties.

The particles may exhibit a native charge or may be charged explicitly using a charge control agent, or may acquire a charge when suspended in a solvent or solvent mixture. Suitable charge control agents are well known in the art; they may be polymeric or non-polymeric in nature or may be ionic or non-ionic. Examples of charge control agents include, but are not limited to, Solsperse 17000 (active polymeric dispersant), Solsperse 9000 (active polymeric dispersant), OLOA® 11000 (succinimide ashless dispersant), Unithox 750 (ethoxylates), Span 85 (sorbitan trioleate), Petronate L (sodium sulfonate), Alcolec LV30 (soy lecithin), Petrostep B100 (petroleum sulfonate) or B70 (barium sulfonate), Aerosol OT, polyisobutylene derivatives or poly(ethylene co-butylene) derivatives, and the like. Other examples of suitable charge control agents are disclosed in U.S. Patent No. 12,195,586, which is incorporated by reference herein in its entirety. In addition to the suspending fluid and charged pigment particles, internal phases may include stabilizers, surfactants and charge control agents. A stabilizing material may be adsorbed on the charged pigment particles when they are dispersed in the solvent. This stabilizing material keeps the particles separated from one another so that the variable transmission medium is substantially non-transmissive when the particles are in their dispersed state.

As is known in the art, dispersing charged particles (typically a carbon black, as described above) in a solvent of low dielectric constant may be assisted by the use of a surfactant. Such a surfactant typically comprises a polar "head group" and a non-polar "tail group" that is compatible with or soluble in the solvent. The non-polar tail group may be a saturated or unsaturated hydrocarbon moiety, or another group that is soluble in hydrocarbon solvents, such as, e.g., a poly(dialkylsiloxane). The polar group may be any polar organic functionality, including ionic materials such as ammonium, sulfonate or phosphonate salts, or acidic or basic groups. Particularly preferred head groups are carboxylic acid or carboxylate groups. In some embodiments, dispersants, such as polyisobutylene succinimide and/or sorbitan trioleate, and/or 2-hexyldecanoic acid are added.

The dispersion may contain one or more stabilizers. Stabilizers suitable for use in the dispersions made according to the various embodiments disclosed herein include, but are not limited to, polyisobutylene and polystyrene. However, only a relatively low concentration of stabilizer may be necessary. A low concentration of stabilizer may assist in maintaining the media in the closed (opaque) or intermediate state, but the size of the hetero-agglomerates of the oppositely charged particles in the open state would be effectively stable without the presence of a stabilizer. For example, the dispersions incorporated in various embodiments may contain, with increasing preference in the amounts listed, less than or equal to 10%, 9%, 8%, 7%, 6%, 5%, 4%, 3%, 2%, and 1% stabilizer based on the weight of the dispersion. In some embodiments, the dispersion may be free of stabilizer.

The fluids used in the variable transmission media in various embodiments will typically be of low dielectric constant (preferably less than 10 and desirably less than 3). The fluids are preferably solvents that have low viscosity, relatively high refractive index, low cost, low reactivity, and low vapor pressure/high boiling point. The fluids are preferably light transmissive and may or may not have an optical property, such as color (e.g., red, green, blue, cyan, magenta, yellow, white, and black), that differs from the optical properties of at least one of the sets of charged particles of the dispersion. Examples of solvents include, but are not limited to, aliphatic hydrocarbons such as heptane, octane, and petroleum distillates such as Isopar ® (Exxon Mobil) or Isane® (Total); terpenes such as limonene, e.g., l-limonene; and aromatic hydrocarbons such as toluene. A particularly preferred solvent is limonene, since it combines a low dielectric constant (2.3) with a relatively high refractive index (1.47). The index of refraction of the internal phase may be modified with the addition of the index matching agents. For example, the aforementioned U.S. Patent No. 7,679,814 describes an electrophoretic medium suitable for use in a variable transmission device in which the fluid surrounding the electrophoretic particles comprises a mixture of a partially hydrogenated aromatic hydrocarbon and a terpene, a preferred mixture being d-limonene and a partially hydrogenated terphenyl, available commercially as Cargille® 5040 from Cargille-Sacher Laboratories, 55 Commerce Rd, Cedar Grove N.J. 07009. In the encapsulated media made according to various embodiments of the present invention, it is preferred that the refractive index of the encapsulated dispersion matches as closely as possible to that of the encapsulating material to reduce haze. In most instances, it is beneficial to have an internal phase with an index of refraction between 1.51 and 1.57 at 550 nm, preferably about 1.54 at 550 nm. In embodiments using a light-transmissive particle that is index matched to the internal phase, the light-transmissive particle will also have an index of refraction between 1.51 and 1.57 at 550 nm, preferably about 1.54 at 550 nm.

In one or more embodiments, the encapsulated fluid may comprise one or more nonconjugated olefinic hydrocarbons, preferably cyclic hydrocarbons. Examples of nonconjugated olefinic hydrocarbons include, but are not limited to, terpenes, such as limonene; phenyl cyclohexane; hexyl benzoate; cyclododecatriene; 1,5-dimethyl tetralin; partially hydrogenated terphenyl, such as Cargille® 5040; phenylmethylsiloxane oligomer; and combinations thereof. A most preferred composition for the encapsulated fluid according to some embodiments comprises cyclododecatriene and a partially hydrogenated terphenyl.

In one or more embodiments, the amount of stabilizing agent included in the encapsulated fluid may be lower than is traditionally used in electrophoretic displays. See, for contrast, U.S. Patent No. 7,170,670. Such stabilizing agents may be large molecular weight free polymers such as polyisobutylene, polystyrene, or poly(lauryl)methacrylate. Accordingly, in some embodiments, the encapsulated fluid (i.e., dispersion) further comprises less than 10% of a stabilizing agent by weight of the dispersion. In some embodiments, the dispersion is free of the stabilizing agent. It is found that by reducing the presence of large molecular-weight polymers, the haze is improved, making the final product more pleasing.

In the open state, the charged particles respond to an electrical field applied to the electrodes to concentrate in volumes defined by the transparent, non-planar, polymer structure.

In some embodiments, the electrophoretic medium is bistable in that the medium can maintain a desired optical state without the application of an electric field. For example, when apertures or obstructions of the open state are bistable, power can be removed completely (i.e., zero volts between the first and second electrodes) after switching, and the apertures or obstructions remain unchanged. Similarly, the absence of apertures in the closed state is stable after switching and removal of power.

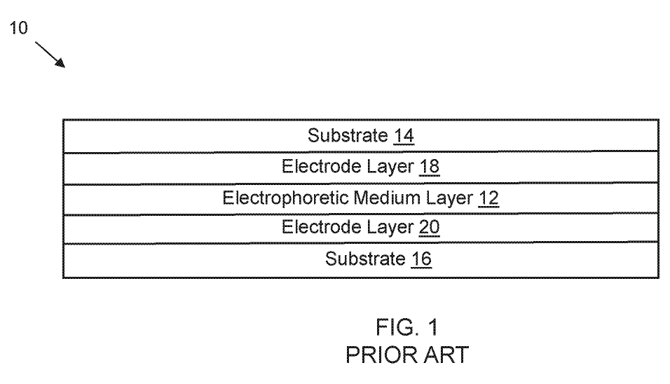

FIG. 1 is a simplified diagram illustrating an exemplary switchable electrophoretic light modulator 10. The light modulator 10 includes an electrophoretic medium layer 12 positioned between a first light-transmissive substrate 14 and a second light-transmissive substrate 16. The major surfaces of the first and second light-transmissive substrates 14, 16 face each other and are juxtaposed parallel.

The first light-transmissive substrate 14 and the second light-transmissive substrate 16 may comprise polymers including acrylate, methacrylate, vinylbenzene, vinylether, or multifunctional epoxides.

A first transparent electrode layer 18 is disposed between the first light-transmissive substrate 14 and the electrophoretic medium layer 12. A second transparent electrode layer 20 is disposed between the second light-transmissive substrate 16 and the electrophoretic layer 12. The electrode layers 18, 20 may each comprise a transparent flexible Polyethylene Terephthalate (PET) film covered on its inner face with a transparent, flexible Indium Tin Oxide (ITO) electrode.

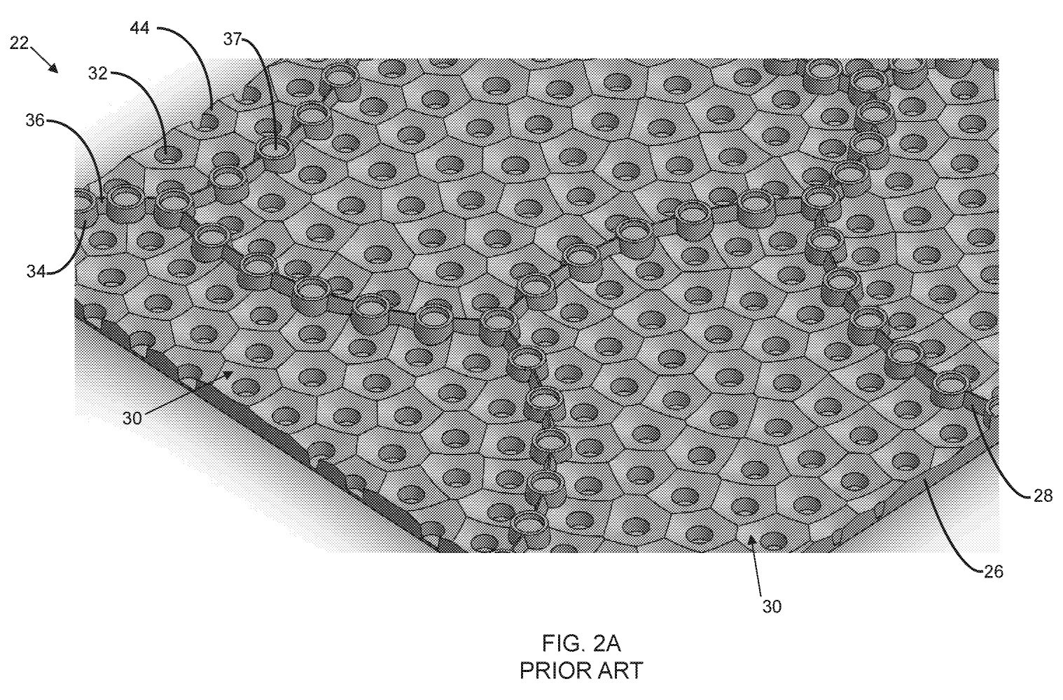

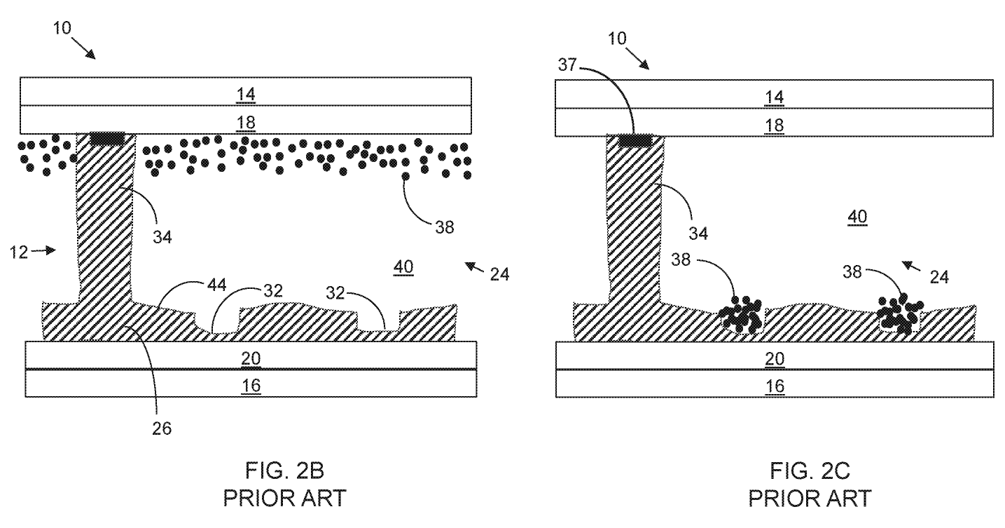

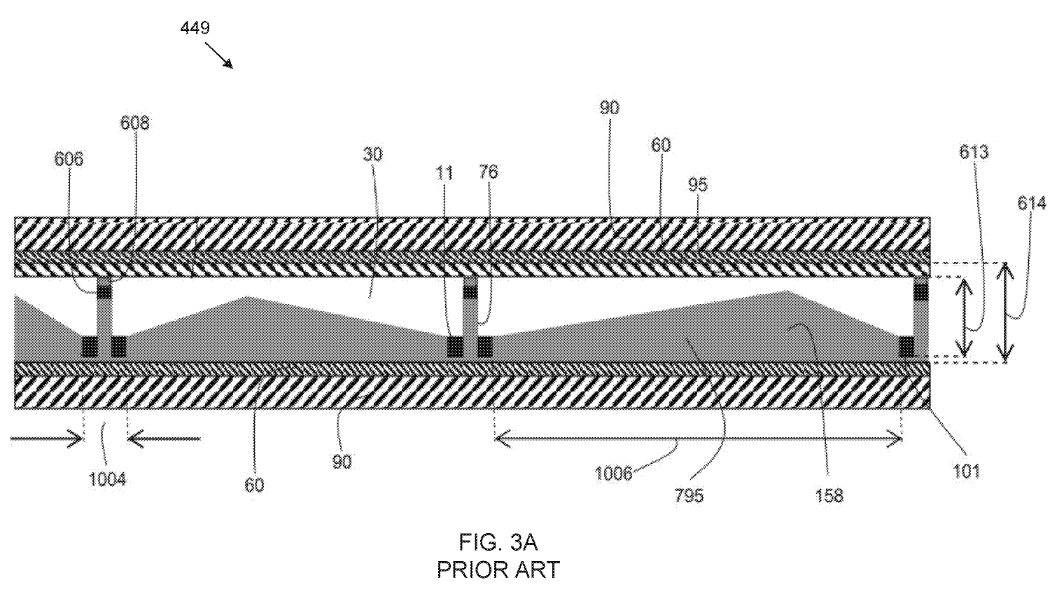

The electrophoretic layer 12 includes a light-transmissive polymer structure on the electrode layer 20. The light-transmissive polymer structure may comprise, e.g., the polymer structure 22 depicted in FIG. 2A (or the polymer structure depicted in FIG. 3A). An electro-optic medium 24 is contained in cells 30 defined by the polymer structure 22. The polymer structure 22 may be formed in an embossing process.

FIGS. 2B and 2C depict operation of a light modulator having the polymer structure 22 depicted in FIG. 2A. The electro-optic medium 24 in the electrophoretic layer 12 comprises charged pigment particles 38 dispersed in a suspending fluid (e.g., a non-polar solvent) 40. The charged particles 38 move through the suspending fluid 40 under the influence of an electric field. Applying a driving voltage between the first and second electrodes 18, 20 causes the electro-optic medium 24 to switch between a first light-absorbing closed state (FIG. 2B) and a second light-transmissive open state (FIG. 2C).

As shown in FIG. 2A, the polymer structure 22 includes a base 26 and a wall structure 28 extending orthogonally from one surface of the base 26. The wall structure 28 defines multiple cells or volumes 30 for receiving and compartmentalizing the electro-optic medium 24. The base 26 of the polymer structure 22 includes a plurality of wells 32 distributed across each of the cells 30 for receiving and concentrating charged pigment particles 38, thereby limiting the space occupied by the particles 38 in the second light-transmissive state (FIG. 2C). The base 26 includes tapered surfaces 44 leading to each of the wells 32 to promote movement of the particles 38 into the wells 32 in the second light-transmissive state.

The wall structure 28 formed on the base 26 includes a plurality of pillar structures 34 and linking wall elements 36 connecting adjacent pillar structures 34. The pillar structures 34 each include a distal surface 37 parallel to the base 26. The distal surfaces 37 are preferably similar in size and shape to the plurality of wells 32. The distal surfaces 37 of the pillar structures 34 are blackened (or otherwise colored) to resemble the wells 32 of the polymer structure 22 when filled with pigment particles 38 in the second light-transmissive state.

FIG. 2B is a simplified cross-sectional view of a portion of the light modulator unit 10 in the dark (closed) state, in which the charged pigment particles 38 in the electro-optic medium 24 are spread across the viewing face and adjacent to the inner face of the electrode layer 18. The charged pigment particles 38 absorb light incident on the unit 10.

FIG. 2C shows the light modulator unit 10 in the open state, in which the charged pigment particles 38 are concentrated in the wells 32 of the polymer structure 22.

The open state forms when a voltage having the opposite polarity to that of the charged particles 38 is applied to the electrode 20 on the substrate 16 to form an electrical field between the opposing electrodes 18, 20. The electrical field drives the charged particles 38 toward the inner face of the substrate 16 and, on encountering the tapered surfaces 44, the particles 38 migrate to and concentrate in the wells 32. The depth of the wells 32 is sufficient to hold the concentrated particles 38 in the open state. It is dependent on the volume needed by the particles 38 to concentrate, and in turn is dependent on the particle loading in the ink’s suspending fluid. The latter determines the light transmission in the dark state. The closed state (FIG. 2B) forms when the polarity of the voltage is reversed, attracting the charged particles 38 to the inner face of the substrate 14 where they spread adjacent its electrode 18. The forming of light states in an electrophoretic device using protrusions is described in more detail in the Applicant’s U.S. Patent No. 10,067,398 titled “An Electrophoretic Device Having a Transparent Light State”. The charged particles 38 may be driven with time-varying voltages, e.g., waveforms that may range in voltage from 0 to ±500V, although typically less.

The electro-optic medium 24 and the polymer structure 22 are preferably optically transparent and a refractive index match. This allows light incident on unit 10, not otherwise absorbed by the pigment particles 38, to be transmitted unhindered (i.e., not refracted or diffracted) by the interface between the suspending fluid of the electro-optic medium 24 and the polymer structure 22.

A sealing layer having, e.g., a polymeric composition, may be applied over the polymer structure 22 to seal the electro-optic medium 24 in the plurality of cells 30. The pillar structures 34 provide structural support and sealing adhesion to the sealing layer.

Additionally, one or more layers of adhesive, such as an optically-clear adhesive available, e.g., from Norland, may be used to bond various films and structures to one another.

FIGS. 3A and 3B illustrate a light modulator 449 with an alternate polymer structure design as disclosed in U.S. Patent No. 10,067,398. FIG. 3A shows a cross-section view of the light modulator 449, and FIG. 3B shows a top plan view of the polymer structure 158 in the light modulator 449. The polymer structure 158 is non-planar and comprises protrusions 795 whose extent coincides with channels 101 and cavities 488.

FIGS. 3A and 3B show the light modulator 449 in an open state. Black charged particles 11 are deflected by (or move over) the surface of protrusions 795 in an electrical field and concentrate in the interstices of protrusions 795 forming apertures 1006. The non-planar, polymer structure 158 has aperiodically arranged protrusions 795 in electrophoretic cell 614. The surface shape, cross-sectional area, cross-sectional geometric form, and orientation of its protrusions 795 are different from each other and can be random or possess a degree of randomness. Protrusions of the type 795 are asymmetrical and have facets with different areas and slopes to enhance the randomness of the apertures 1006 defined by the protrusions in light states. Light encountering embodiment 449 diffracts randomly and avoids the perception of a diffraction pattern about a bright light source viewed through the device.

Channels 101 coincide with the interstices of protrusions 795 and hold concentrated, black, charged particles 11 in the open state. The channels 101 are recesses in the non-planar, polymer structure 158 and are at least partly below the level of the protrusions 795 as shown in FIG. 3A. The concentrated black, charged particles can fill a volume in the interstices of protrusions proportional to the particle loading in the electrophoretic ink (e.g., a particle loading in the range 5% to 30% by mass of the ink). In viewing a face of the device in the open state, the concentrated particles form light absorbing areas (i.e., obstructions) that limit the maximum light transmittance. The channels 101 minimize the face area covered by concentrated, black, charged particles 11 in the open state by concentrating (or stacking) the particles in the z-axis of the cell 614.

In light modulator 449, each protrusion 795 is closely surrounded by its channel 101 and a polymer wall 76 and their extent define an electrophoretic ink cavity 488. In the FIG. 3B view, the black mask 606 covering polymer walls 76 is in peripheral areas of the apertures (i.e., it does not form part of an aperture’s circumference) in the second light state with wall edges adjacent concentrated black particles 11 as shown by light obstruction dimension 1004. Advantageously, the black mask 606 covering walls 76 does not diffract light because along its circumference (in a face view), it does not coincide with a light transmitting area. In an alternate design, the channel 101 is absent and black charged particles 11 concentrate in the volume between the protrusion 795 and its surrounding wall 76 and adjacent the bottom electrode 60. More generally, the polymer wall sections (or lengths in the face view) coincide with peripheral areas of protrusions so that in the open state, concentrated black charged particles are adjacent to an edge of the wall section.

The non-planar, polymer structure 158 is continuous in the cell 614 and isolates the electrophoretic ink layer 613 from the bottom electrode 60. Both the discrete apertures 1006 and the continuous light obstructing area 1004, i.e., the concentrated black charged particles area and the black mask area, are random, or possess a degree of randomness. To minimize or avoid the perception of a diffraction pattern arising from the black mask 606 on polymer walls 76, the arrangement of the polymer walls and the cavities 488 they form, are aperiodic.

In other light modulators related to light modulator unit 449, the cavities, polymer walls and channels coincide with the extent of more than one microstructure. For example, each electrophoretic ink cavity, defined by its surrounding polymer walls 76, contains two or more protrusions with part of their extent coinciding with the walls, and each protrusion is surrounded by a channel.

The non-planar polymer structure 158 in device 449 is derived from a photosensitive polymer (cured photoresist) exposed by a laser beam or electron beam (e-beam) and developed to reveal the surface of microstructures. Preferably each microstructure is independently written, asymmetrical, and randomly orientated. More preferably, the parameters that define each are uncorrelated, and the close-packing of microstructures and cavities has random centers.

The size of apertures and obstructions can be maximized to minimize their total circumference per square unit of face area. The upper limit is determined by the resolution of a typical viewer’s eye. Preferably apertures and obstructions are sufficiently small so that their geometric form in a face view is not apparent. In devices where the microstructures are protrusions and the black charged particles form discrete apertures in the open state, the maximum angle subtended by an aperture to a viewer at a required viewing distance is one arcminute (corresponding to 290 microns at a viewing distance of 1 meter) and preferably 0.6 arcminutes (corresponding to 174.5 microns at 1 meter). The subtended angle of the aperture pitch (i.e. aperture and concentrated charged particle area) is double these limits. In devices where the microstructures are recesses and the black charged particles form discrete obstructions in the second light state, the maximum angle subtended by an obstruction to a viewer at a required viewing distance is one arcminute (corresponding to about 290 microns at a viewing distance of 1 meter) and preferably 0.6 arcminutes (corresponding to about 174.5 microns at 1 meter). The subtended angle of the obstruction pitch (i.e. obstruction and light transmitting area) is double these limits.

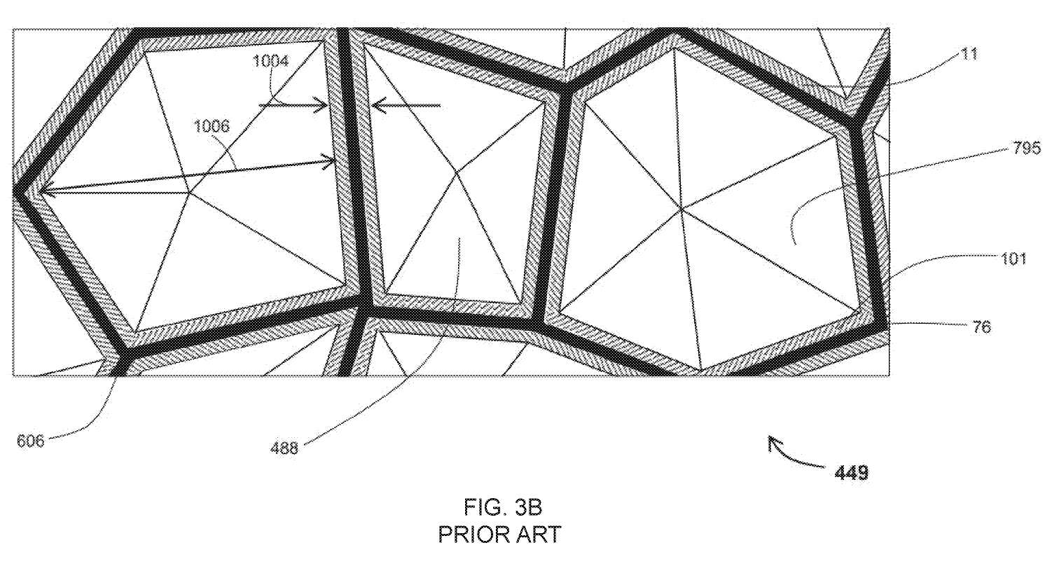

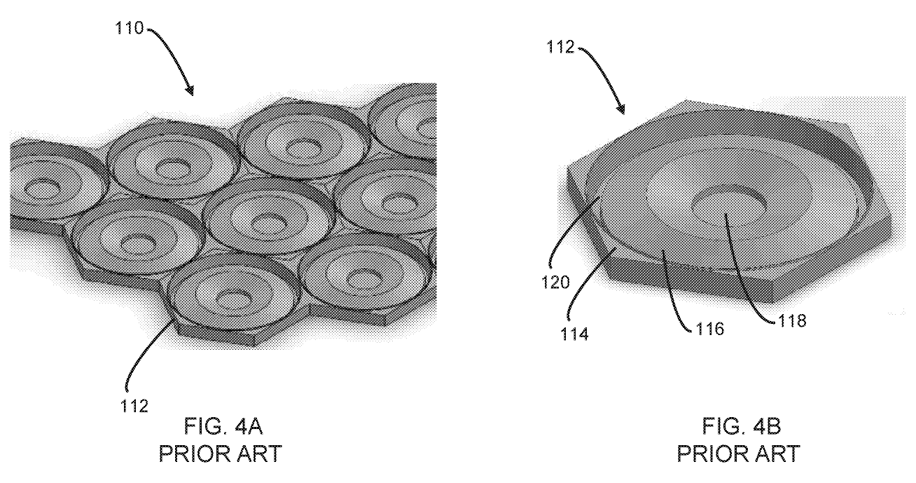

FIG. 4A is a perspective view of a portion of another example of a prior art polymer structure 110 forming part of an electrophoretic ink layer of a switchable light modulator. The polymer structure 110 includes walls 114 defining a plurality of cells 112. FIG. 4B is an enlarged view of one of the cells 112 of the polymer structure 110. Each of the cells 114 includes a protrusion 116. In this example, the protrusions 116 have a toroidal shape, defining a center well 118 and an annular well 120 extending around each protrusion 116 for collecting pigment particles.

### Switchable Light Modulator Displaying Different Colors On Opposite Viewing Sides

A switchable light modulator capable of attenuating light transmission as well as displaying different colors on opposite viewing sides is disclosed. Such a light modulator may be used, e.g., in windows of buildings or vehicles for displaying different colors or images as well as modulating light.

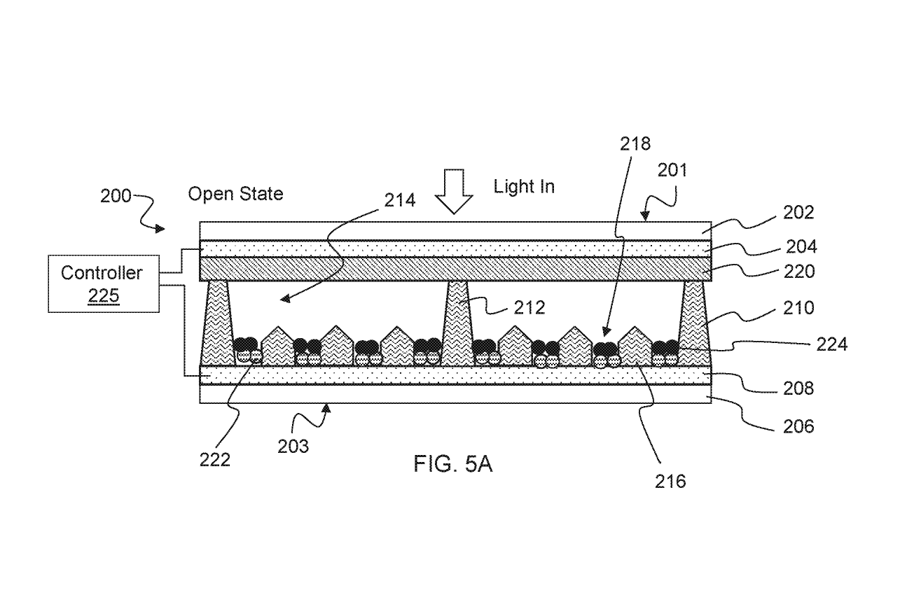

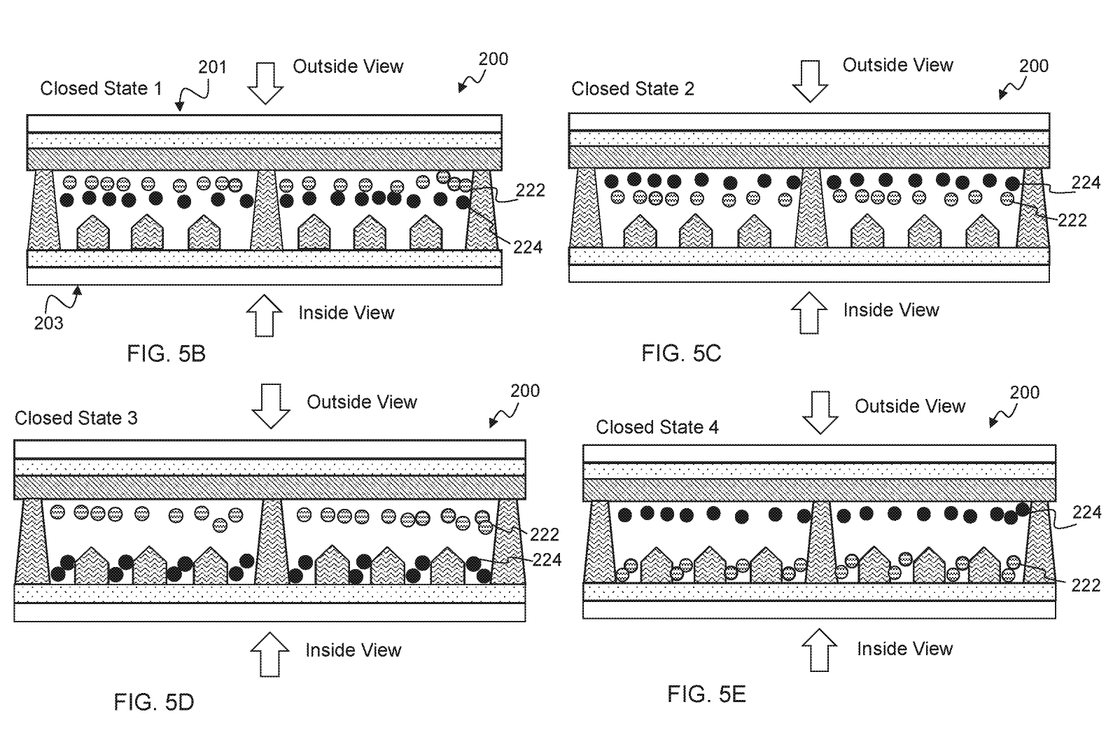

FIGS. 5A-5E are simplified drawings showing a portion of an exemplary switchable light modulator 200 according to one aspect of the invention in various modes of operation. The switchable light modulator 200 includes a first light-transmissive substrate 202 at a first viewing side 201 (e.g., facing the outside of a vehicle or building receiving incident light), a first electrode layer 204 superposed on one side of the first light-transmissive substrate 202, a second light-transmissive substrate 206 facing an opposite second viewing side 203 (e.g., facing the interior of a vehicle or building), and a second electrode layer 208 superposed on one side of the second light-transmissive substrate 206. A light-transmissive polymer structure 210 is disposed between the first electrode layer 204 and the second electrode layer 208. In one or more embodiments, the light-transmissive polymer structure 210 is similar to the polymer structures described above in FIGS. 2-4. The polymer structure 210 includes walls 212 defining a plurality of cells 214. Each of the cells 214 includes a plurality of protrusions 216 and wells 218 therebetween. In one or more embodiments, the protrusions 216 are pyramidal or conical-shaped and the wells 218 have an annular shape and encircle the protrusions 216. In one or more embodiments, the wells 218 comprise recesses surrounded by the protrusions 216. In general, the wells 218 can comprise any recessed space in the polymer structure 210 suitable for collecting pigment particles, including channels, cavities, openings, etc.

An electrophoretic medium is contained in each of the plurality of cells 214. The cells 214 are enclosed by a sealant layer 220. The electrophoretic medium comprises at least two types of charged pigment particles dispersed in a non-polar solvent having different optical characteristics or colors. For example, in the embodiments illustrated in FIGS. 5A-5E, the electrophoretic medium includes a first type of charged pigment particle (a plurality of charged reflective pigment particles 222) and a second type of charged pigment particle (a plurality of charged absorptive pigment particles 224). However, it should be understood that any combination of charged pigment particles having different optical characteristics or colors can be included in the electrophoretic medium of the light modulators disclosed herein. For example, the pigment particles 222 and the pigment particles 224 could each comprise charged reflective pigment particles having different colors.

As noted above, light reflective pigment (i.e., light scattering-type pigment) refers to pigment that deflects light’s wave vector, and with low light absorption for at least part of the visible spectrum. It could have low light absorption over all of the visible spectrum, thereby expressing a white appearance, or it could absorb light across only part of the visible spectrum, thereby expressing a color. Light absorbing-type pigment refers to pigment that absorbs light at certain wavelengths and allows the rest of the light transmit through, that is, it does not scatter light strongly. When pigment absorbs light at all visible wavelength, it will appear black. Otherwise, it can express a color.

The switchable light modulator 200 also includes a controller 225, which is operatively coupled to and configured to apply a set of driving voltages between the first and second electrodes 204, 208 to drive the electrophoretic medium among a plurality of different optical states corresponding to various modes of operation, as discussed below. The controller may include one or more processors and memories and/or one or more programmable hardware elements, and is intended to include any types of processors, CPUs, microcontrollers, digital signal processors, or other devices capable of executing software instructions. In some embodiments, the controller is a component of the switchable light modulator 200. In some embodiments, the controller is remotely located from the switchable light modulator.

As shown in FIGS. 5A-5E, the switchable light modulator 200 can be switched among a plurality of exemplary optical states by varying the arrangements and positioning of the charged reflective pigment particles 222 and the charged absorptive pigment particles 224 in the electrophoretic medium. The optical states include an open state (FIG. 5A) and various closed states (FIGS. 5B-5E).

In the open state depicted in FIG. 5A, the charged reflective pigment particles 222 and the charged absorptive pigment particles 224 are concentrated in the wells 218 in the polymer structure 210 to enable maximal transmittance of the incident light at the first light-transmissive substrate 202 through the switchable light modulator 200. In one or more embodiments, the switchable light modulator 200 has greater than 50% incident light transmittance in the open state. In the illustrated example, the charged absorptive pigment particles 224 are arranged between the first viewing side 201 of the switchable light modulator 200 and the charged reflective pigment particles 222. Accordingly, incident light strikes the charged absorptive pigment particles 224 instead of the charged reflective pigment particles 222 and is not scattered, resulting in the modulator expressing low haze at the first viewing side 201. The relative positions of the particles 222, 224 depicted in FIG. 5A can be reversed, as desired, using appropriate driving waveforms.

In the closed states depicted in FIGS. 5B and 5C, the charged absorptive pigment particles 224 and the charged reflective pigment particles 222 are generally maximally distributed across each cell. In one or more embodiments, the charged absorptive pigment particles 224 and the charged reflective pigment particles 222 substantially block transmittance of the incident light through the switchable light modulator 200. In FIG. 5B, the charged reflective pigment particles 222 are positioned in a layer between the charged absorptive pigment particles 224 and the first electrode layer 204. In this state, a viewer would see the color of the charged reflective pigment particles 222 on the first viewing side 201 of the modulator 200 and the color of the charged absorptive pigment particles 224 on the second viewing side 203 of the modulator 200.

In FIG. 5C, the charged absorptive pigment particles 224 are positioned in a layer between the charged reflective pigment particles 222 and the first electrode layer 204. In this state, a viewer would see the color of the charged absorptive pigment particles 224 on the first viewing side 201 of the modulator 200 and the color of the charged reflective pigment particles 222 on the second viewing side 203 of the modulator 200.

In the closed states depicted in FIGS. 5D and 5E, one set of pigment particles is maximally spread across each cell (the charged reflective pigment particles 222 in FIG. 5D and the charged absorptive pigment particles 224 in FIG. 5E), and the other set of pigment particles is concentrated in the wells 218.

In the FIG. 5D state, the viewer would see the color of the charged reflective pigment particles 222 on the first viewing side 201 of the modulator 200. The viewer would also see the color of the charged reflective pigment particles 222 on the second viewing side 203 of the modulator 200, marked to some degree potentially with the color of the charged absorptive pigment particles 224 at the wells 218.

In the FIG. 5E state, the viewer would see the color of the charged absorptive pigment particles 224 on the first viewing side 201 of the modulator 200. The viewer would see the color of the charged absorptive pigment particles 224 potentially marked with the color of the charged reflective pigment particles 222 at the wells 218 on the second viewing side 203 of the modulator 200.

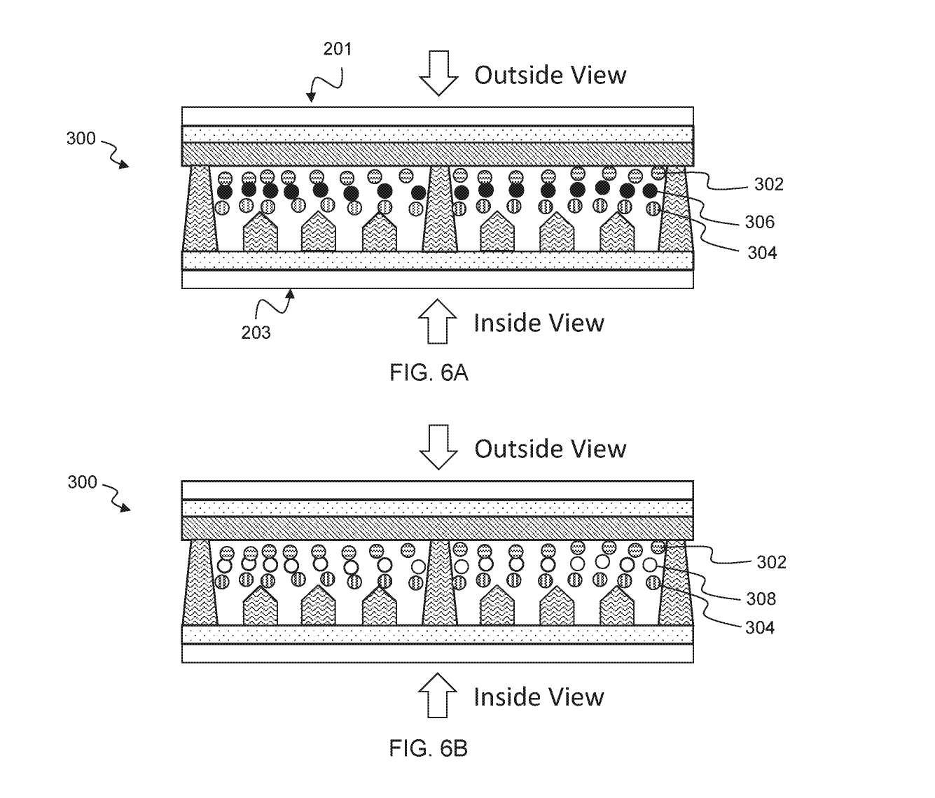

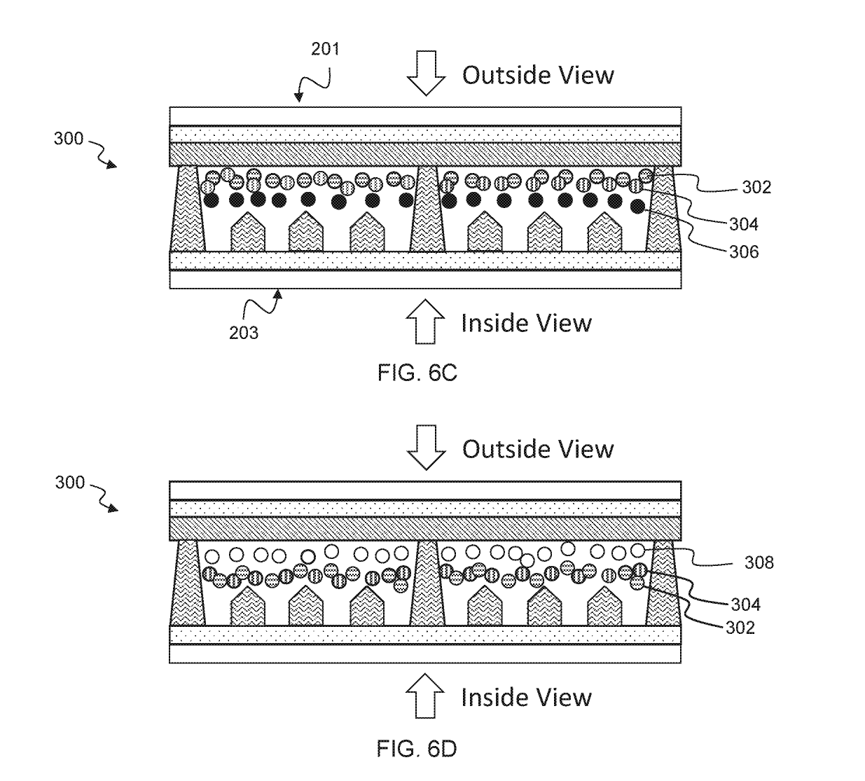

FIGS. 6A-6D are simplified drawings showing a portion of an exemplary switchable light modulator 300 according to another aspect of the invention. The light modulator 300 is the same as or similar to the light modulator 200 depicted in FIGS. 5A-5E, but includes three types of charged pigment particles having different optical characteristics or colors. For example, in one or more embodiments, the electrophoretic medium comprises a plurality of charged reflective pigment particles 302 and a plurality of charged reflective pigment particles 304 having different colors. The electrophoretic medium also includes a third set of charged pigment particles comprising light-absorbing black pigment particles 306 (shown in FIGS. 6A and 6C) or reflective (light-scattering) white pigment particles 308 (shown in FIGS. 6B and 6D). FIGS. 6A and 6B show closed optical states in which the charged pigment particles 302, 304, 306, 308 are generally maximally distributed across each cell. In FIG. 6A, the charged light-absorbing black pigment particles 306 are positioned in a layer between the charged reflective pigment particles 302 and the charged reflective pigment particles 304. In this state, a viewer would see the color of the charged reflective pigment particles 302 on the first viewing side 201 of the modulator 300 and the color of the charged reflective pigment particles 304 on the second viewing side 203 of the modulator 300. The charged light-absorbing black pigment particles 306 have the effect of darkening the colors seen by the viewer on both viewing sides 201 and 203.

In FIG. 6B, the charged light-scattering white pigment particles 308 are positioned in a layer between the charged reflective pigment particles 302 and the charged reflective pigment particles 304. As with the FIG. 6A embodiment, a viewer would see the color of the charged reflective pigment particles 302 on the first viewing side 201 of the modulator 300 and the color of the charged reflective pigment particles 304 on the second viewing side 203 of the modulator 300. The charged light-scattering white pigment particles 308 have the effect of lightening the colors seen by the viewer on both viewing sides 201 and 203.

In FIG. 6C, the charged reflective pigment particles 302 and the charged reflective pigment particles 304 form a mixture to produce a new color at the first viewing side 201. The light-absorbing black pigment particles 306 are distributed between the mixture of the particles 302, 304 and the second viewing side 203. In this state, a viewer would see the new color produced by the mixture on the first viewing side 201 and black on the second viewing side 203.

In FIG. 6D, the charged reflective pigment particles 302 and the charged reflective pigment particles 304 form a mixture to produce a new color at the second viewing side 203. The light-scattering white pigment particles 308 are distributed between the mixture of the particles 302, 304 and the first viewing side 201. In this state, a viewer would see the new color produced by the mixture on the second viewing side 203 and white on the first viewing side 201.

Numerous other combinations of pigment particle arrangements are, of course, possible, and the illustrative examples described herein are not intended to be limiting. For example, in the FIG. 6C example, the charged light-absorbing black pigment particles 306 could be replaced by the charged light-scattering white pigment particles 308 or particles of another color or even a combination of particles producing a new color. Similar and other variations are possible in the FIG. 6D example.

In one or more embodiments, the charged absorptive pigment particles are electrically charged black pigment particles. For example, the black pigment particles can be carbon black particles, metal oxide black particles, organic black particles, or inorganic and organic composite black particles. Alternatively, the charged absorptive pigment particles comprise a combination of different particles (e.g., cyan, magenta, and yellow particles) having given optical characteristics such that a mixture of the particles absorbs substantially all visible radiation, i.e., produces a process black color. The pigment particles may optionally be surface treated or polymerized, depending on particular applications. For surface treatment, a surface treatment agent can be either chemically or physically bonded to the particle surfaces. Polymerization can be performed either on surface treated particles or directly on the particles. The polymerization can be grafting polymerization, dispersion polymerization, emulsion polymerization, suspension polymerization, and other similar polymerization techniques with suitable modification.

In one or more embodiments, the charged reflective pigment particles are electrically charged particles having one of various colors, including, but not limited to, white, brown, red, green, orange, yellow, violet, and purple. In one or more embodiments, the charged reflective pigment particles are metal oxide particles, organic particles, or inorganic and organic composite particles. The charged reflective pigment particles may optionally be surface treated or polymerized, depending on desired applications. For surface treatment, a surface treatment agent can be either chemically or physically bonded to the particle surfaces. Polymerization can be performed either on surface treated reflective particles or directly on the reflective particle surfaces. Polymerization can be grafting polymerization, dispersion polymerization, emulsion polymerization, suspension polymerization, or other similar polymerization techniques with suitable modification. In some embodiments, the charged reflective pigment particles 222 comprise materials to increase thermal reflectivity, selected from Ag, Sn, In, Ti, Zn, Si, La, Ce, Zr, Fe, Al, Cr, Co, Ni, Cu, Pt, Rh, Mn, Ta, W, V, Mo, stainless steel, tin-doped indium oxide, antimony-doped tin oxide, antimony oxide doped tin oxide, lanthanum hexaboride, aluminium-doped zinc oxide, indium-doped zinc oxide, tin-doped zinc oxide, silicon-doped zinc oxide, fluorine-doped zinc oxide, gallium-doped zinc oxide, fluorine-doped tin oxide, cadmium tin oxide, tungsten oxide, tungsten oxide composite, cobalt oxide, chromium oxide, iron oxide, nickel oxide, titanium nitride, cerium hexaboride, B₁O₃, Ιn₂0₃, Sn0₂, Ti0₂, TiOx, Zn0₂, ZnS, Si₃N₄, Nb₂0₅, Ta₂0₅, Si0₂, and MgF₂.

In one or more embodiments, the charged pigment particles may comprise charged light emitting pigments, such as Quantum-dots-containing particles or fluorescent particles. Such particles could be used in light modulator devices for various purposes including for providing decorative effects.

The controller 225 is configured to apply a set of driving voltages between the first and second electrodes 204, 208 to drive the electrophoretic medium to various optical states including the states depicted in FIGS. 5A-5E and 6A-6B. The driving voltages can include combinations of alternating current (AC) and direct current (DC) components. The AC components generally comprise rapidly-alternating positive and negative voltage pulses, e.g., in the form of a square wave or a periodic function having other shapes such as, e.g., an approximate sine wave. A DC component can be added to AC components by making the two voltages (in the case of a square wave) of different magnitudes, or by changing the duty cycle, which is the ratio of time elapsed at the two voltage extremes from 50:50 to another ratio such as, e.g., 40:60 or 60:40.

AC components of waveforms with a frequency range between about 10 Hz and 100 Hz can induce macroscopic fluid flow in the electrophoretic medium. The AC drive components should have a generally high amplitude because the fluid flow is driven by a force that scales with the square of the electric field strength. This macroscopic fluid flow effectively spreads pigment particles out across the cell and can achieve the closed states depicted in FIGS. 5B, 5C, 6A and 6B, DC biases can be applied to the electrodes to achieve the open state of FIG. 5A. DC biases can also be used to promote fine vertical ordering of the various pigment layers shown in each of the figures. Another waveform technique suitable for achieving desired vertical ordering of pigment types involves “push-pull” waveform structures described, e.g., in U.S. Patent No. 12,087,244, which is incorporated by reference herein. A typical push-pull waveform structure may comprise a series of pulse pairs of opposite sign, where the pulses in one direction have a larger amplitude but shorter duration, and the pulses in the other direction have a smaller amplitude but longer duration. In a typical push-pull waveform, the total net impulse of these pulse pairs is close to zero, but this DC-balance condition is not always adhered to. Low-amplitude push-pull waveform structures can be used to achieve fine control over the vertical ordering of the various pigment particle layers, and a large AC amplitude waveform can be used to disperse pigment out of the wells and across the display surface. The large amplitude AC component will induce substantial macroscopic dispersing flow and lower-amplitude push-pull waveforms will not induce such significant flow because, as noted above, the flow scales in accordance with the square of the applied voltage. The ability of the lower-amplitude push-pull waveforms to separate layers of pigment types is the result of threshold behavior (or similar non-linear voltage response) for various pigment packs, with different pigment packs exhibiting different threshold behavior.

In one or more embodiments, the charged absorptive pigment particles 224 and the charged reflective pigment particles 222 in FIGS. 5A-5E have the same charge polarity. The open state of FIG. 5A can be achieved by applying a voltage bias to the second electrode layer 208 of opposite polarity to the charge on the absorptive and reflective pigment particles 222, 224 to draw the pigment particles 222, 224 into the wells 218. The voltage bias is preferably interrupted by voltage pulses of opposite polarity having a short duration (e.g., 5-10 ms).

The various closed states illustrated in FIGS. 5B, 5C, 6A and 6B,can be achieved in a two-stage process. In the first stage, a generalized closed state can be achieved where all pigments are fairly well dispersed across each cell 214. The first stage waveform can comprise a high-amplitude AC waveform with a DC bias induced by a duty cycle that is not 50:50 or with an added voltage bias. Alternatively, a series of waveform segments can be applied, each comprising a DC bias followed by an AC drive, and where the entire first stage of the waveform is comprised of about three to five such waveform segments with a DC bias added at the end of the stage.

Once the dispersed state is achieved in the first stage, vertical ordering of the pigment particle types can be achieved in the second stage using DC voltage pulses and push-pull waveform segments. The pulse amplitudes and durations of the push-pull waveform segments can be determined in various ways including experimentally.

In FIGS. 5D and 5E, one type of pigment particle is in the open state (the pigment particles are collected in the wells 218) and the other type of pigment particle is in the closed (the pigment particles are distributed across the cells 214). In embodiments where the pigment particles 222, 224 have the same charge polarity, a two stage approach can be used to achieve the desired optical states. In the first stage, the open state is achieved as described above, with an appropriate voltage bias interrupted by short voltage pulses of opposite polarity to draw the two types of pigment particles to the wells 218. After the pigment particles have moved into the wells 218, a selective closed state is achieved using a waveform having an AC drive with a DC voltage bias (or with an asymmetric duty cycle that achieves a DC bias). The combination of AC drive and DC voltage bias is tuned such that the flow induced by the AC drive will entrain one type of pigment particles to move out of the wells 218 and become distributed across the top of each cell. The DC voltage bias will compel the other type of pigment particles to stay near the electrode 206 and remain in the wells 218. It has been found that the DC bias will act more strongly on the pigment particles having the larger zeta potential. A DC bias voltage of sufficient strength should be used to compel one of the pigment types to remain in the wells 218 while allowing the other pigment particle type to be entrained and moved to the top of the cells. This general approach can thereby be used to achieve separation between one set of pigments in the open (collected) state and one in the closed (dispersed) state.

In one or more embodiments, the charged absorptive pigment particles 224 and the charged reflective pigment particles 222 have the opposite charge polarity. In the examples provided below, the charged reflective pigment particles 222 are negatively charged, and the charged absorptive pigment particles 224 are positively charged. The open state depicted in FIG. 5A can be achieved utilizing driving voltages that act on differences in threshold behavior of the charged reflective pigment particles 222 and charged absorptive pigment particles 224. In one or more embodiments, the charged reflective pigment particles 222 are drawn into the wells 218 with a positive drive voltage pulse applied to the second electrode layer 208. After that, the charged absorptive pigment particles 224 are moved toward the wells 218 using a series of negative, low-amplitude voltage pulses. The amplitude and duration of the negative pulses are configured so as to not re-disperse the charged reflective pigment particles 222 out of the wells 218.

In one or more embodiments, the set of driving voltages for driving the electrophoretic medium to the closed state depicted in FIG. 5D include application of a negative bias to the second electrode layer 208 to push the (negatively) charged reflective pigment particles 222 toward the opposite first electrode layer 204 and to pull the (positively) charged absorptive pigment particles 224 into the wells 218. It has been found that pigment particle motion is enhanced by interrupting this negative voltage drive with positive voltage interruptions. Thus, in one or more embodiments, the set of driving voltages comprises a series of alternating positive and negative voltage pulses repeated multiple times. In one or more embodiments, the positive pulses have an amplitude of 100 V to 200 V and a pulse width of 5 to10 ms, and the negative pulses have an amplitude of -100 to -200 V and a pulse width of 90 to 95 ms. The closed state of FIG. 5E can be similarly achieved using oppositely charged drive voltages.

As noted above, improved spreading or distribution of the charged reflective pigment particles 222 can be achieved by applying high-amplitude alternating positive and negative voltage pulses. High amplitude pulses with a negative bias induce a flow pattern inside each cell 214 that effectively carries charged reflective pigment particles 222 out of wells 218 and distributes the particles across the cells 214. The high amplitude pulses induce a dispersing flow that increases approximately proportionately with the square of the driving voltage amplitude. A negative voltage bias is added to alternating pulses, either simultaneously in the form of a constant added negative voltage or by adjusting the duty cycle of the drive pulses off of 50:50 (50% of time positive, 50% of time negative) to a value that favors the negative voltage, such as 40:60 or 30:70, or by consecutively by switching between the alternating pulse drive and a negative voltage drive in consecutive time segments. In one or more embodiments, the series of alternating positive and negative voltage pulses has a frequency of 10 Hz to 80 Hz. In one or more embodiments, and the positive and negative voltage pulses have a reduced amplitude towards the end of the series of pulses in order to allow the charged absorptive pigment particles 224 to settle into the wells 218 without being entrained in fluid flow out of the wells 218.

By reducing the negative voltage bias during the alternating pulse drive, the closed optical state shown in FIG. 5B can be achieved where both charged reflective pigment particles and the charged absorptive pigment particles 224 are distributed or spread across the cells 214.

The closed states illustrated in FIGS. 5C and 5E can be similarly achieved using a waveform comprising a series of alternating positive and negative voltage pulses having a voltage bias that is positive instead of negative.

It will be apparent to those skilled in the art that numerous changes and modifications can be made in the specific embodiments of the present invention described above without departing from the scope of the invention. Accordingly, the whole of the foregoing description is to be construed in an illustrative and not in a limitative sense.

1. A switchable light modulator having a first viewing side and an opposite second viewing side, comprising:
a first light-transmissive substrate at the first viewing side;
a first electrode layer superposed on one side of the first light-transmissive substrate;
a second light-transmissive substrate at the second viewing side;
a second electrode layer superposed on one side of the second light-transmissive substrate;
a light-transmissive polymer structure between the first electrode layer and the second electrode layer, the light-transmissive polymer structure including a base superposed on the first electrode layer or the second electrode layer and a wall structure extending orthogonally from the base defining a plurality of cells, each of the plurality of cells including a plurality of wells in the base;
an electrophoretic medium contained in each of the plurality of cells, the electrophoretic medium comprising a non-polar fluid and a first set of charged pigment particles and a second set of charged pigment particles dispersed in the non-polar fluid, the first and second sets of charged pigment particles having different colors and being selectively movable through the non-polar fluid under influence of an electric field; and
a controller configured to apply a set of driving voltages between the first and second electrode layers to selectively drive the electrophoretic medium among a plurality of optical states including at least the following:
(a) an open state, in which the first and second sets of charged pigment particles are concentrated in the wells in the polymer structure to promote transmittance of incident light through the switchable light modulator;
(b) a first closed state, in which the second set of charged pigment particles is spread across each cell and the first set of charged pigment particles is spread across each cell between the second set of charged pigment particles and the first electrode layer such that the color of the first set of charged pigment particles is displayed across the first viewing side, and the color of the second set of charged pigment particles is displayed across the second viewing side; and
(c) a second closed state, in which the first set of charged pigment particles is spread across each cell and the second set of charged pigment particles is spread across each cell between the first set of charged pigment particles and the first electrode layer such that the color of the second set of charged pigment particles is displayed across the first viewing side, and the color of the first set of charged pigment particles is displayed across the second viewing side.

2. The switchable light modulator of claim 1, wherein the controller is configured to apply an additional set of driving voltages between the first and second electrode layers to selectively drive the electrophoretic medium among a plurality of additional optical states including at least the following:
(d) a third closed state, in which the first set of charged pigment particles is spread across each cell at the first electrode layer, and the second set of charged pigment particles are concentrated in the wells in the polymer structure such that the first viewing side displays the color of the first set of charged pigment particles, and the second viewing side displays the color of the first set of charged pigment particles marked with the color of the second set of charged pigment particles at the wells; and
(e) a fourth closed state, in which the second set of charged pigment particles is spread across each cell at the first electrode layer, and the first set of charged pigment particles are concentrated in the wells in the polymer structure such that the first viewing side displays the color of the second set of charged pigment particles, and the second viewing side displays the color of the second set of charged pigment particles marked with the color of the first set of charged pigment particles at the wells.

3. The switchable light modulator of claim 1, wherein the electrophoretic medium further comprises a third set of charged pigment particles dispersed in the non-polar fluid, the third set of charged pigment particles having a different color than the first and second sets of charged pigment particles, and
wherein the controller is configured to apply driving voltages between the first and second electrode layers to selectively drive the electrophoretic medium among a plurality of additional optical states including at least the following:
(f) a fifth closed state, in which the first set of charged pigment particles is spread across each cell at the first electrode layer, the second set of charged pigment particles is spread across each cell, and the third set of charged pigment particles is spread across each cell between the first and second sets of charged pigment particles such that the first viewing side displays the color of the first set of charged pigment particles influenced by the third set of charged pigment particles, and the second viewing side displays the color of the second set of charged pigment particles influenced by the third set of charged pigment particles; and
(g) a sixth closed state, in which the second set of charged pigment particles is spread across each cell at the first electrode layer, the first set of charged pigment particles is spread across each cell, and the third set of charged pigment particles is spread across each cell between the first and second sets of charged pigment particles such that the first viewing side displays the color of the second set of charged pigment particles influenced by the third set of charged pigment particles, and the second viewing side displays the color of the first set of charged pigment particles influenced by the third set of charged pigment particles.

4. The switchable light modulator of claim 3, wherein the first and second sets of charged pigment particles comprise light-scattering charged pigment particles or light-absorbing charged pigment particles, and wherein the third set of charged pigment particles comprises
(i) light-absorbing black pigment particles or a combination of different pigment particles producing a process black color or
(ii) light-scattering white pigment particles.

5. The switchable light modulator of claim 4, wherein the light-absorbing charged pigment particles are black particles or a combination of different pigment particles producing a process black color, and wherein the light-scattering charged pigment particles are white, brown, red, blue, cyan, green, orange, yellow, violet, or purple.

6. The switchable light modulator of claim 1, wherein the electrophoretic medium further comprises a third set of charged pigment particles dispersed in the non-polar fluid, the third set of charged pigment particles having a different color than the first and second sets of charged pigment particles, and
wherein the controller is configured to apply driving voltages between the first and second electrode layers to selectively drive the electrophoretic medium among a plurality of additional optical states including at least the following:
(h) a seventh closed state, in which a mixture of the first and second sets of charged pigment particles are spread in a layer across each cell at the first electrode layer, and the third set of charged pigment particles is spread across each cell between the mixture of the first and second sets of charged pigment particles and the second electrode layer such that the first viewing side displays the color produced by the mixture of the first and second sets of charged pigment particles, and the second viewing side displays the color of the third set of charged pigment particles; and
(i) an eighth closed state, in which the third set of charged pigment particles is spread across each cell at the first electrode layer, the mixture of the first and second sets of charged pigment particles is spread across each cell between the third set of charged pigment particles and the second electrode layer such that the first viewing side displays the color of the third set of charged pigment particles and the second viewing side displays the color produced by the mixture of the first and second sets of charged pigment particles.

7. The switchable light modulator of claim 1, wherein
(i) the first set of charged pigment particles comprises light-scattering charged pigment particles and the second set of charged pigment particles comprises light-absorbing charged pigment particles,
(ii) the first set of charged pigment particles comprises light-absorbing charged pigment particles and the second set of charged pigment particles comprises light-scattering charged pigment particles,
(iii) the first set of charged pigment particles and the second set of charged pigment particles comprise light-absorbing charged pigment particles, or
(iv) the first set of charged pigment particles and the second set of charged pigment particles comprise light-scattering charged pigment particles.

8. The switchable light modulator of claim 1, wherein the base of the light-transmissive polymer structure includes (i) a plurality of pyramidal or conical-shaped features, each surrounded by an annular well or (ii) a plurality of toroidal shaped features, each having a center well and surrounded by an annular well.

9. A window of a building or a vehicle including the switchable light modulator of claim 1.

10. A sunroof of a vehicle including the switchable light modulator of claim 1, wherein the first viewing side faces outside the vehicle and the second viewing side faces inside the vehicle, wherein in the first closed state the first viewing side displays the color of the first set of charged pigment particles, which color is associated with an exterior body color of the vehicle, and the second viewing side displays the color of the second set of charged pigment particles, which color is associated with an interior color of the vehicle.

11. A method, comprising:
providing a switchable light modulator having a first viewing side and an opposite second viewing side, comprising a first light-transmissive substrate at the first viewing side; a first electrode layer superposed on one side of the first light-transmissive substrate;
a second light-transmissive substrate at the second viewing side; a second electrode layer superposed on one side of the second light-transmissive substrate; a light-transmissive polymer structure between the first electrode layer and the second electrode layer, the light-transmissive polymer structure including a base superposed on the first electrode layer or the second electrode layer and a wall structure extending orthogonally from the base defining a plurality of cells, each of the plurality of cells including a plurality of wells in the base; and
an electrophoretic medium contained in each of the plurality of cells, the electrophoretic medium comprising a non-polar fluid and a first set of charged pigment particles and a second set of charged pigment particles dispersed in the non-polar fluid, the first and second sets of charged pigment particles having different colors and being selectively movable through the non-polar fluid under influence of an electric field; and
applying a set of driving voltages between the first and second electrode layers to selectively drive the electrophoretic medium among a plurality of optical states including at least the following:
(a) an open state, in which the first and second sets of charged pigment particles are concentrated in the wells in the polymer structure to promote transmittance of incident light through the switchable light modulator;
(b) a first closed state, in which the second set of charged pigment particles is spread across each cell and the first set of charged pigment particles is spread across each cell between the second set of charged pigment particles and the first electrode layer such that the color of the first set of charged pigment particles is displayed across the first viewing side, and the color of the second set of charged pigment particles is displayed across the second viewing side; and
(c) a second closed state, in which the first set of charged pigment particles is spread across each cell and the second set of charged pigment particles is spread across each cell between the first set of charged pigment particles and the first electrode layer such that the color of the second set of charged pigment particles is displayed across the first viewing side, and the color of the first set of charged pigment particles is displayed across the second viewing side.

12. The method of claim 11, further comprising applying an additional set of driving voltages between the first and second electrode layers to selectively drive the electrophoretic medium among a plurality of additional optical states including at least the following:
(d) a third closed state, in which the first set of charged pigment particles is spread across each cell at the first electrode layer, and the second set of charged pigment particles is concentrated in the wells in the polymer structure such that the first viewing side displays the color of the first set of charged pigment particles, and the second viewing side displays the color of the first set of charged pigment particles marked with the color of the second set of charged pigment particles at the wells; and
(e) a fourth closed state, in which the second set of charged pigment particles is spread across each cell at the first electrode layer, and the first set of charged pigment particles is concentrated in the wells in the polymer structure such that the first viewing side displays the color of the second set of charged pigment particles, and the second viewing side displays the color of the second set of charged pigment particles marked with the color of the first set of charged pigment particles at the wells.

13. The method of claim 11, wherein the electrophoretic medium further comprises a third set of charged pigment particles dispersed in the non-polar fluid, the third set of charged pigment particles having a different color than the first and second sets of charged pigment particles, and wherein the method further comprises applying driving voltages between the first and second electrode layers to selectively drive the electrophoretic medium among a plurality of additional optical states including at least the following:
(f) a fifth closed state, in which the first set of charged pigment particles is spread across each cell at the first electrode layer, the second set of charged pigment particles is spread across each cell, and the third set of charged pigment particles is spread across each cell between the first and second sets of charged pigment particles such that the first viewing side displays the color of the first set of charged pigment particles influenced by the third set of charged pigment particles, and the second viewing side displays the color of the second set of charged pigment particles influenced by the third set of charged pigment particles; and
(g) a sixth closed state, in which the second set of charged pigment particles is spread across each cell at the first electrode layer, the first set of charged pigment particles is spread across each cell, and the third set of charged pigment particles is spread across each cell between the first and second sets of charged pigment particles such that the first viewing side displays the color of the second set of charged pigment particles influenced by the third set of charged pigment particles, and the second viewing side displays the color of the first set of charged pigment particles influenced by the third set of charged pigment particles.

14. The method of claim 13, wherein the first and second sets of charged pigment particles comprise light-scattering charged pigment particles or light-absorbing charged pigment particles, and wherein the third set of charged pigment particles comprises
(i) light-absorbing black pigment particles or a combination of different pigment particles producing a black color or
(ii) light-scattering white pigment particles.

15. The method of claim 11, wherein the electrophoretic medium further comprises a third set of charged pigment particles dispersed in the non-polar fluid, the third set of charged pigment particles having a different color than the first and second sets of charged pigment particles, and wherein the method further comprises applying driving voltages between the first and second electrode layers to selectively drive the electrophoretic medium among a plurality of additional optical states including at least the following:
(h) a seventh closed state, in which a mixture of the first and second sets of charged pigment particles is spread in a layer across each cell at the first electrode layer, and the third set of charged pigment particles is spread across each cell between the mixture of the first and second sets of charged pigment particles and the second electrode layer such that the first viewing side displays the color produced by the mixture of the first and second sets of charged pigment particles, and the second viewing side displays the color of the third set of charged pigment particles; and
(i) an eighth closed state, in which the third set of charged pigment particles is spread across each cell at the first electrode layer, the mixture of the first and second sets of charged pigment particles is spread across each cell between the third set of charged pigment particles and the second electrode layer such that the first viewing side displays the color of the third set of charged pigment particles and the second viewing side displays the color produced by the mixture of the first and second sets of charged pigment particles.

16. The method of claim 11, wherein the first and second sets of charged pigment particles comprise light-scattering charged pigment particles or light-absorbing charged pigment particles.

17. The method claim 16, wherein the light-absorbing charged pigment particles are black particles or a combination of different pigment particles producing a black color, and wherein the light-scattering charged pigment particles are white, brown, red, blue, cyan, green, orange, yellow, violet, or purple.

18. The method of claim 11, wherein
(i) the first set of charged pigment particles comprises light-scattering charged pigment particles and the second set of charged pigment particles comprises light-absorbing charged pigment particles,
(ii) the first set of charged pigment particles comprises light-absorbing charged pigment particles and the second set of charged pigment particles comprises light-scattering charged pigment particles,
(iii) the first set of charged pigment particles and the second set of charged pigment particles comprise light-absorbing charged pigment particles, or
(iv) the first set of charged pigment particles and the second set of charged pigment particles comprise light-scattering charged pigment particles.

19. The method of claim 11, wherein the set of driving voltages for driving the electrophoretic medium to one of the optical states includes a series of alternating positive and negative voltage pulses repeated a plurality of times to induce macroscopic fluid flow in the electrophoretic medium to spread one or more of the sets of charged pigment particles out across each of the plurality of cells.

20. The method of claim 11, wherein the set of driving voltages for driving the electrophoretic medium to one of the optical states includes a direct current bias or a push-pull waveform to promote ordering of the sets of charged pigment particles.
